(19) United States
(12) Patent Application Publication
(10) Pub. No.: US 2025/0213419 A1
(43) Pub. Date: Jul. 3, 2025

(54) MASSAGE DEVICE

(71) Applicant: Shenzhen Cosinno Technology Co., Ltd., Shenzhen (CN)

(72) Inventors: Nianqing Zhang, Shenzhen (CN); Wanqi Zhang, Shenzhen (CN)

(21) Appl. No.: 19/001,456

(22) Filed: Dec. 25, 2024

(30) Foreign Application Priority Data
Dec. 29, 2023 (CN) 202323658620.8

(51) Int. Cl. A61H 7/00; A61H 15/00

(52) U.S. Cl. CPC A61H 7/007; A61H 15/0078; A61H 2015/0042; A61H 2201/1215; A61H 2201/14; A61H 2201/1418; A61H 2201/1671; A61H 2201/1676

(57) ABSTRACT

A massage device includes a shell. A driving assembly and two groups of massage assemblies are arranged in the shell; each group of massage assemblies includes a massage swing arm and a kneading gripper; the driving assembly includes a motor and a spindle; the motor is in transmission connection with the spindle; and two groups of massage swing arms are arranged on both ends of the spindle respectively, wherein the massage swing arms are arranged on the spindle through a bevel seat; each massage swing arm is provided with a fixing shaft; swing grooves are arranged in the shell; the fixing shaft is arranged in the swing grooves; the kneading gripper is arranged on the spindle through a bevel cam; the kneading gripper is provided with a deflection chute; a limiting shaft is arranged in the shell; and the limiting shaft is arranged in the deflection chute.

### CROSS-REFERENCE TO RELATED APPLICATIONS

This application claims priority to Chinese Patent Application No. 202323658620.8, filed on Dec. 29, 2023, the content of which is incorporated herein by reference in its entirety.

### TECHNICAL FIELD

The present application relates to the technical field of massage devices, in particular to a massage device.

### BACKGROUND

The common massage machine core uses a swing structure of a massage head to achieve the effect of kneading massage, but the kneading range of the kneading head is limited, and there is no corresponding structure to cooperate. The kneading head cannot better simulate the technique of pinching the shoulder and neck by hands to massage. On the existing market, the rotation direction of the gripper cam is single, and the swing matching is in one direction only to form kneading massage. Therefore, the massage effect of the existing massage device is not comfortable.

### SUMMARY

The present application provides a massage device, including a shell; a driving assembly and two groups of massage assemblies are arranged in the shell; the massage assemblies are arranged on both sides of the driving assembly; each group of massage assemblies includes a massage swing arm and a kneading gripper; the driving assembly includes a motor and a spindle; the motor is in transmission connection with the spindle; and the two groups of massage assemblies are arranged on both ends of the spindle respectively.

The massage swing arm is arranged on the spindle through a bevel seat; the bottom of the massage swing arm is provided with a fixing shaft; a swing groove is arranged below the massage swing arm; and the fixing shaft is arranged in the swing groove.

The kneading gripper is arranged on the spindle through a bevel cam; the bevel cam rotates with the spindle; the kneading gripper is provided with a deflection chute; a limiting shaft is arranged in the shell; and the limiting shaft is arranged in the deflection chute.

### BRIEF DESCRIPTION OF THE DRAWINGS

FIG. 1 is an assembly schematic diagram of a massage device in an embodiment of the present application;

FIG. 2 is an exploded schematic diagram of a massage device in an embodiment of the present application;

FIG. 3 is an exploded schematic diagram of a hidden shell of a massage device in an embodiment of the present application;

FIG. 4 is a top view of a massage device in an embodiment of the present application;

FIG. 5 is a schematic diagram of a hidden shell of a massage device of A-A section in FIG. 4;

FIG. 6 is a top view of the present application in a first use state of an embodiment;

FIG. 7 is a top view of the present application in a second use state of an embodiment;

FIG. 8 is a structural schematic diagram of a massage swing arm in an embodiment of the present application;

FIG. 9 is a schematic diagram of B-B section in FIG. 8;

FIG. 10 is an exploded schematic diagram of a massage swing arm in an embodiment of the present application; and

FIG. 11 is a structural schematic diagram of a massage ball head in an embodiment of the present application.

### DESCRIPTION OF NUMERALS

1. shell; 11. lower housing; 12. upper housing; 121. avoidance hole;
2. massage assembly; 21. massage swing arm; 211. first fixing piece; 212. bevel seat; 2121. connecting hole; 213. swing groove; 214. fixing shaft; 215. swing arm shaft; 2151. positioning part; 2152. lug boss; 216. massage ball head; 2161. first ball head part; 2162. second ball head part; 2163. installing hole; 21631. first hole section; 21632. annular convex block; 21633. second hole section; 21634. positioning groove; 217. elastic element; 22. kneading gripper; 221. second fixing piece; 222. bevel cam; 2221. locking shaft; 2222. connecting shaft; 223. deflection chute; 3. driving assembly; 301. lower driving housing; 302. through hole; 303. bearing groove; 304. upper driving housing; 305. limiting shaft; 31. motor; 311. output worm; 32. spindle; 321. bearing sleeve; 322. locking hole; 33. duplex gear; 331. inner gear; 332. outer gear; 34. main rotating shaft gear.

### DETAILED DESCRIPTION OF THE EMBODIMENTS

To explain the technical content, achieved purposes and effects of the present application in detail, the present application is explained below in combination with the embodiments and the drawings.

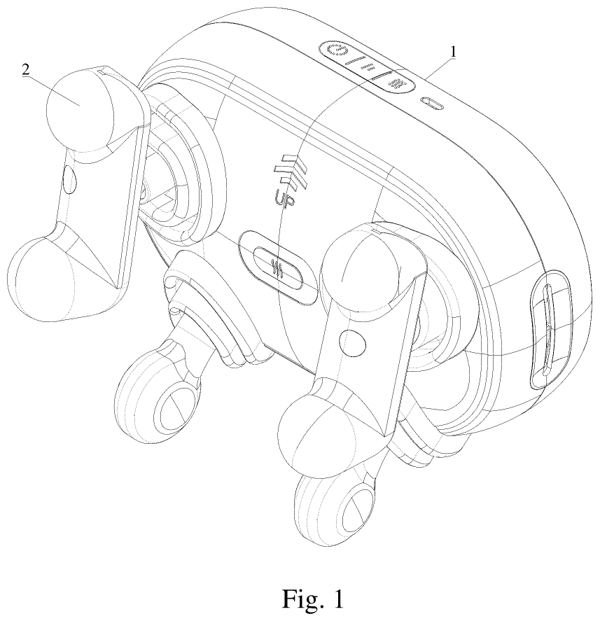

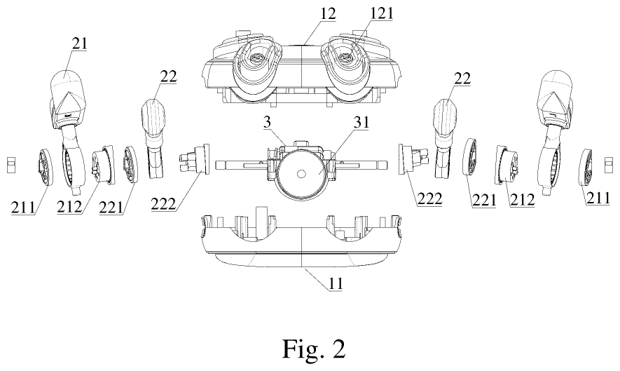

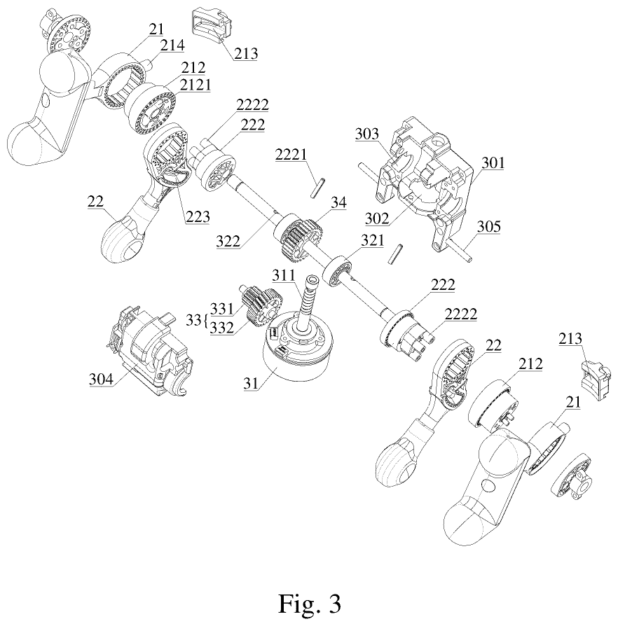

By referring to FIG. 1, FIG. 2 and FIG. 3, the present application provides a massage device, including a shell 1. A driving assembly 3 and two groups of massage assemblies 2 are arranged in the shell 1; and the massage assemblies 2 are arranged on both sides of the driving assembly 3. The driving assembly 3 drives the massage assemblies 2 to swing, so that the massage assemblies 2 achieve the effect of kneading massage.

Each group of the massage assemblies 2 includes a massage swing arm 21 and a kneading gripper 22. The massage swing arm 21 swings relatively on both sides to form clamping massage. The kneading gripper 22 is matched with the massage swing arm 21 for clamping kneading. The driving assembly 3 is used for swinging the massage swing arms 21 and the kneading grippers 22; the driving assembly 3 includes a driving housing, a motor 31, a main rotating shaft gear 34 and a spindle 32; and the motor 31, the main rotating shaft gear 34 and the spindle 32 are all arranged in the driving housing.

Moreover, the motor 31 is used for driving the main rotating shaft gear 34, and the main rotating shaft gear 34 is penetrated on the spindle 32, so that the spindle 32 rotates with the main rotating shaft gear 34. The two groups of massage assemblies 2 are arranged on both ends of the spindle 32 respectively. Therefore, the massage swing arm 21 and the kneading gripper 22 swing through the rotation of the spindle 32 and the internal coordination of the massage assemblies 2.

By referring to FIG. 2, FIG. 3 and FIG. 5, in one or more embodiments, in the massage assemblies 2, the massage swing arm 21 is arranged on the spindle 32 through the bevel seat 212; the bevel seat 212 rotates with the spindle 32, but the massage swing arm 21 does not rotate with the bevel seat 212 and swigs according to the bevel of the bevel seat 212. Moreover, the bottom of the massage swing arm 21 is provided with a fixing shaft 214; a swing groove 213 is arranged below the massage swing arm 21; the swing groove 213 is arranged along one direction; the fixing shaft 214 is arranged in the swing groove 213; and the fixing shaft 214 can only swing within the range of the swing groove 213. Therefore, the massage swing arm 21 swings back and forth along with the matching between the bevel seat 212 and the swing groove 213.

By referring to FIG. 2, FIG. 3 and FIG. 5 continuously, the kneading gripper 22 in the massage assembly 2 is arranged on the spindle 32 through the bevel cam 222; the bevel cam 222 rotates with the spindle 32, but the kneading gripper 22 does not rotate with the bevel cam 222, and swings with the bevel of the bevel cam 222. Moreover, the kneading gripper 22 is provided with a deflection chute 223 for limiting; the driving housing is provided with a limiting shaft 305; and the limiting shaft 305 is arranged in the deflection chute 223. Through the matching of the cam structure and the limitation of the limiting shaft 305 and the deflection chute 223, the kneading gripper 22 can swing back and forth in the forward and backward direction and the left and right direction.

By referring to FIG. 3, the kneading gripper 22 is provided with a deflection chute 223 for limiting; and the limiting shaft 305 is fixedly arranged in the deflection chute 223. The kneading gripper 22 can generate eccentric rotation on the bevel cam 222 through the cam structure. Due to the arrangement of the limiting shaft 305 and the deflection chute 223, the kneading gripper 22 deflects in the forward and backward direction under the push of the cam structure.

Moreover, the bevel cam 222 is provided with a bevel structure. Due to the adjustment of the bevel angle during rotation, the kneading gripper 22 on the fixed bevel deflects in the left and right direction, so that the kneading gripper 22 can swing back and forth in the front and back direction and the left and right direction.

In the massage device provided in the present application, through the matching of the bevel cam 222, the bevel seat 212 and the driving assembly 3 on the massage assemblies 2, the kneading gripper 22 of the massage assembly 2 can swing back and forth to four directions of the left, right, front and back simultaneously, so as to achieve a more comfortable kneading effect, which is more effective than the simple front and back swing. Moreover, by swinging left and right, and front and back, the massage assembly 2 can cover a wider area, making the massage effect more comprehensive. Swinging left and right, and front and back can provide stimulation in more directions, and the massage experience increases the three-dimensional sense, thereby promoting more effective blood circulation.

By referring to FIG. 2 and FIG. 3 continuously, the driving assembly 3 is provided with a driving housing, so that each assembly can be arranged in the driving housing, wherein the driving housing includes an upper driving housing 304 and a lower driving housing 301; and the upper driving housing 304 and the lower driving housing 301 are spliced into a whole. The spindle 32 is arranged on the lower driving housing 301, and both ends penetrate through the lower driving housing 301 and are connected with the massage assembly 2.

By referring to FIG. 3, in one or more embodiments, the motor 31 is arranged outside the lower driving housing 301, penetrates through the lower driving housing 301 and is connected with an internal structure. The lower driving housing 301 is provided with a through hole 302; the motor 31 is connected with an output worm 311; the motor 31 drives the output worm 311 to rotate; and the output worm 311 extends into the lower driving housing 301 through the through hole 302.

Wherein the motor 31 is connected with duplex gears 33; the duplex gears 33 are provided with an inner gear 331 and an outer gear 332; the duplex gears are arranged in the lower driving housing 301; and the body of the motor 31 is clamped outside the lower driving housing 301.

In one or more embodiments, the output worm 311 connected with the motor 31 is engaged with the outer gear 332, and the outer gear 332 can be engaged with a spiral end of the output worm 311 so that the output worm 311 drives the duplex gears 33 to rotate. Wherein the inner gear 331 of the duplex gears 33 is engaged with the main rotating shaft gear 34 on the spindle 32. Therefore, the main rotating shaft gear 34 can be driven to rotate, so that the spindle 32 rotates.

In one or more embodiments, to facilitate the rotation of the spindle 32 on the lower driving housing 301, two bearing sleeves 321 are penetrated on the spindle 32, and the spindle 32 can freely rotate in the bearing sleeves 321. Wherein the lower driving housing 301 is provided with two bearing grooves 303, and the bearing sleeves 321 are embedded into the bearing grooves 303 so that the spindle 32 can fixedly rotate on the lower driving housing 301.

In one or more embodiments, the spindle 32 rotates through the engagement of various gears, and the massage assemblies 2 are arranged on both ends of the spindle 32 to rotate. The kneading gripper 22 and the massage arm are arranged on the spindle 32 through the bevel cam 222 and the bevel seat 212 respectively.

By referring to FIG. 2, in one or more embodiments, one side of the bevel cam 222 provided with a bevel is provided with a second fixing piece 221; the second fixing piece 221 is locked with the bevel cam 222; and the second fixing piece 221 fixedly sleeves the kneading gripper 22 on the bevel cam 222 to prevent the kneading gripper 22 from dropping from the bevel cam 222. The outer side of the bevel seat 212 provided with a bevel is provided with a swing arm fixing piece 211, the first fixing piece 211 is locked with the bevel seat 212, and the massage swing arm 21 is fixedly sleeved on the bevel seat 212 to prevent the massage swing arm 21 from dropping from the bevel seat 212.

By referring to FIG. 3, in one or more embodiments, the bevel cam 222 and the bevel seat 212 rotate with the spindle 32 to make the kneading gripper 22 swing with the massage swing arm 21; the inner ring of the bevel cam 222 is provided with a locking shaft 2221; and the spindle 32 is provided with a locking hole 322. The locking shaft 2221 is inserted into the locking hole 322 so that the bevel cam 222 can be fixed on the spindle 32 and can rotate together with the spindle 32. By referring to FIG. 3, in one or more embodiments, to drive the bevel seat 212 to rotate, the bevel cam 222 is provided with a connecting shaft 2222; the connecting shaft 2222 is arranged axially relative to the bevel seat 212; the bevel seat 212 is provided with a connecting hole 2121; and the connecting shaft 2222 is inserted into the connecting hole 2121. The first fixing piece 211 and the second fixing piece 221 are provided with matching perforations, so that the connecting shaft 2222 can penetrate through the perforations and conduct inserting fit with the connecting hole 2121. Thus, the bevel cam 222 can drive the bevel seat 212 to rotate, so that the massage swing arm 21 can swing through the bevel seat 212.

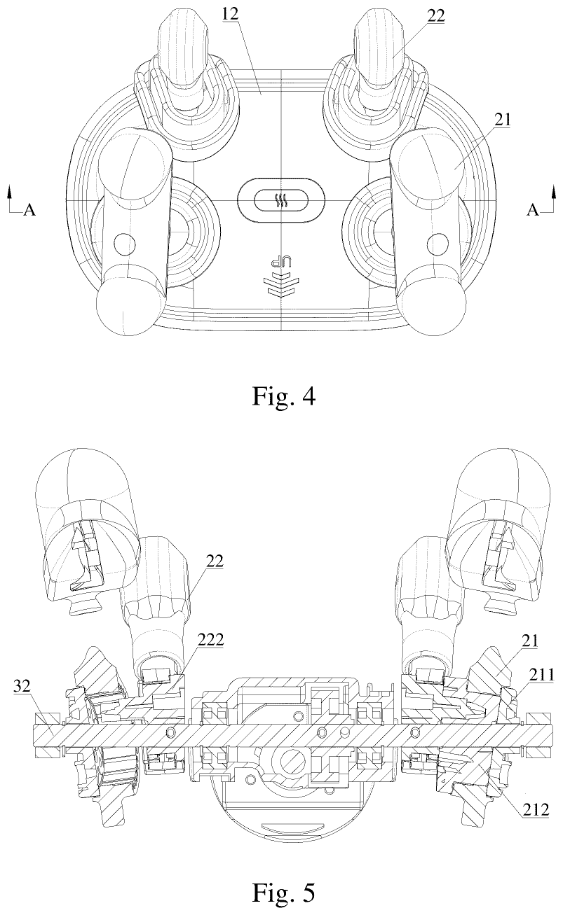

By referring to FIG. 3, FIG. 4 and FIG. 5 continuously, the kneading gripper 22 deflect in left and right, and front and back through the bevel cam 222 and the deflection chute 223, which can simulate the kneading effect. The massage swing arm 21 also generates active deflection through the bevel seat 212, which can simulate the massage effect.

By referring to FIG. 3, in one or more embodiments, the limiting shaft 305 is arranged on both sides outside the lower driving housing 301; the kneading gripper 22 is located outside the driving housing; the kneading gripper 22 is provided with a deflection chute 223 for limiting; and the limiting shaft 305 is arranged in the deflection chute 223. The kneading gripper 22 of the massage device designed in the present application is arranged on the bevel cam 222, and the kneading gripper deflects left and right through the rotation of the bevel cam 222. In the swing process, the kneading gripper is limited by the limiting shaft 305 and the deflection chute 223, and the kneading gripper 22 deflects front and back under the influence of the eccentric cam structure of the bevel cam 222. The kneading gripper 22 can swing back and forth in the front and back direction and the left and right direction.

By referring to FIG. 2, in one or more embodiments, the shell 1 includes an upper housing 12 and a lower housing 11; the driving assembly 3 is arranged in the lower housing 11; the swing grooves 213 are arranged on both sides in the lower housing 11; and the swing grooves 213 are arranged along the axial direction of the spindle 32. The fixing shaft 214 at the bottom of the massage swing arm 21 is arranged in the swing groove 213, and the fixing shaft 214 can only swing within the range of the swing groove 213. The swing direction of the massage swing arm 21 is limited by the fixing shaft 214, and the massage swing arm 21 swings back and forth in the left and right direction following the bevel of the bevel seat 212.

By referring to FIG. 5, in one or more embodiments, the massage swing arm 21 and the kneading gripper 22 are exposed outside the upper housing 12 and can extend out for kneading massage. The upper housing 12 is provided with a plurality of avoidance holes 121 to facilitate the massage swing arm 21 and the kneading gripper 22 to extend.

In one or more embodiments, the massage assemblies 2 are arranged in a mirror image on the driving assembly 3, the massage swing arms 21 are arranged on the spindle 32 near a position of an end, and the kneading grippers 22 are arranged on the spindle 32 near a position of the motor 31. The massage swing arms 21 are arranged on two outermost sides of the massage device, and the kneading grippers 22 are arranged in a relatively inward and lower position to facilitate kneading.

In the present application, through the matching of the bevel cam 222, the bevel seat 212 and the driving assembly 3 on the massage assemblies 2, the kneading gripper 22 of the massage assembly 2 can swing back and forth to four directions of the left, right, front and back simultaneously, so as to achieve a better kneading effect, which is more effective than the simple front and back swing. Moreover, by swinging left and right, and front and back, the massage assembly 2 can cover a wider area, making the massage effect more comprehensive. Swinging left and right, and front and back can provide stimulation in more directions, and the massage experience increases the three-dimensional sense, thereby promoting more effective blood circulation.

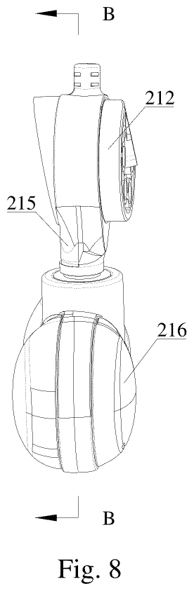

By referring to FIG. 8, in one or more embodiments, the massage swing arm 21 includes a swing arm shaft 215 and a massage ball head 216; one end of the swing arm shaft 215 is provided with the massage ball head 216; and the other end of the swing arm shaft 215 is arranged on the spindle through the bevel seat 212.

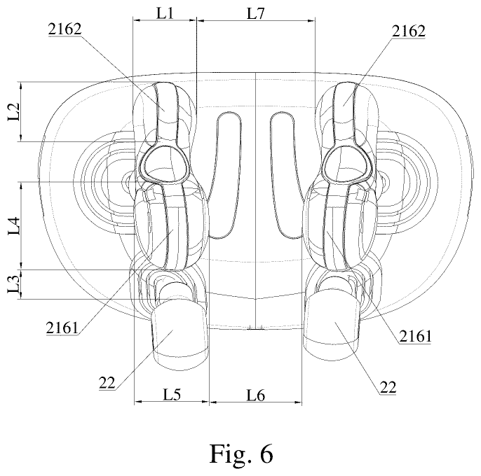

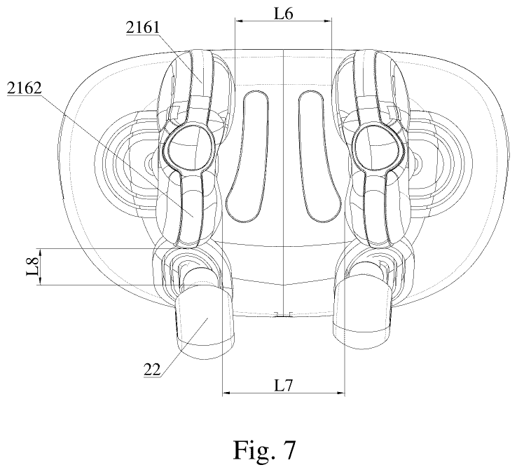

By referring to FIG. 6 and FIG. 7, in one or more embodiments, the massage ball head 216 and the swing arm shaft 215 are rotatably connected, and the massage ball head 216 includes a first ball head part 2161 and a second ball head part 2162. A user can rotate the massage ball head 216 so that the massage ball head 216 includes two use states: The first use state is: the first ball head part 2161 is located on one side of the massage swing arm 21 near the kneading gripper 22, and the second ball head part 2162 is located on one side of the massage swing arm 21 away from the kneading gripper 22 (as shown in FIG. 6). In the first use state, the first ball head part 2161 massages the shoulder position, and the second ball head part 2162 massages the neck position. The second use state is: the first ball head part 2161 is located on one side of the massage swing arm 21 away from the kneading gripper 22, and the second ball head part 2162 is located on one side of the massage swing arm 21 near the kneading gripper 22 (as shown in FIG. 7). In the second use state, the first ball head part 2161 massages the neck position, and the second ball head part 2162 massages the shoulder position.

In one or more embodiments, the width L5 of the first ball head is greater than the width L1 of the second ball head. Under the action of position limitation of the swing arm shaft 215 on the massage ball head 216, the spacing between two first ball heads is L6, and the spacing between two second ball heads is L6. The user can select the first use state or the second use state by rotating the massage ball head 216. The massage ball head 216 can meet the use needs of users of different sizes through the first use state and the second use state. The spacing L1 of the massage device for the shoulder massage position in the first use state is greater than the spacing L2 for the shoulder massage position in the second use state, so the first use state of the massage device can better meet the shoulder massage needs of users with wide shoulder size, and the second use state can better meet the shoulder massage needs of users with narrow shoulder size. Therefore, the massage device designed in the present application can provide good massage experience for users of different shapes.

By referring to FIG. 6 and FIG. 7 continuously, in one or more embodiments, the length L4 of the first ball head is greater than the length L2 of the second ball head. Under the action of position limitation of the swing arm shaft 215 on the massage ball head 216, when the massage device is in the first use state, the spacing between the bottom of the massage ball head 216 and the kneading gripper 22 is L3 (as shown in FIG. 6); and when the massage device is in the second use state, the spacing between the bottom of the massage ball head 216 and the kneading gripper 22 is L8 (as shown in FIG. 7), wherein spacing L3>spacing L8. The user can adjust the spacing between the massage ball head 216 and the kneading gripper 22 by selecting the first use state and the second use state to obtain different massage feelings.

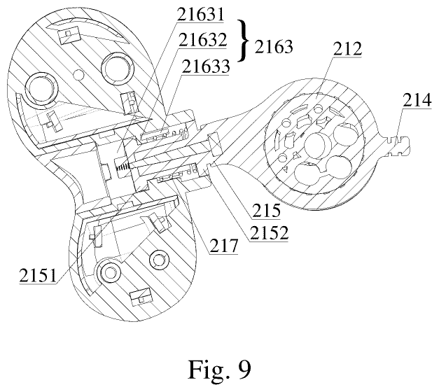

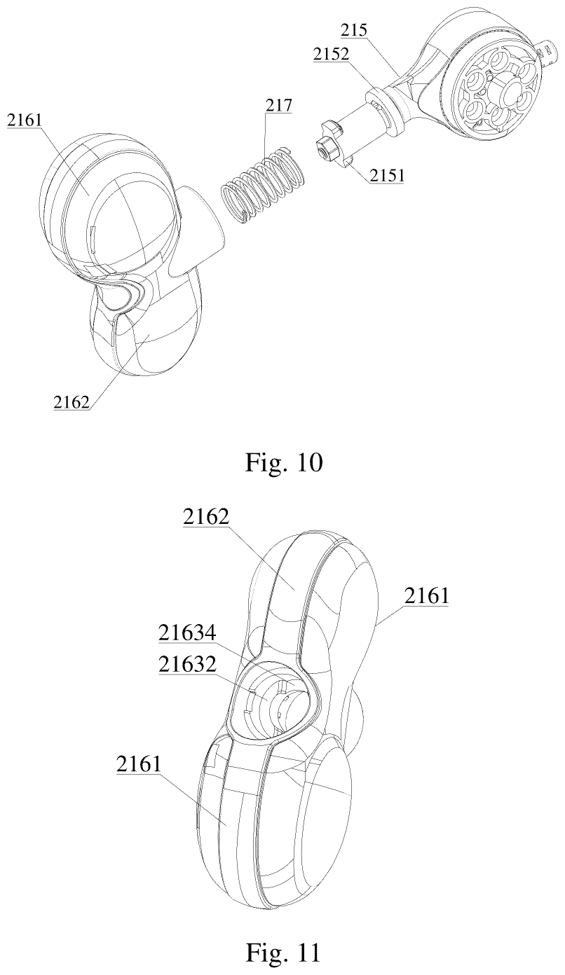

By referring to FIG. 9 and FIG. 10, in one or more embodiments, the massage ball head 216 is provided with an installing hole 2163; the swing arm shaft 215 is movably arranged in the installing hole 2163; the installing hole 2163 includes a first hole section 21631, an annular convex block 21632 and a second hole section 21633 arranged successively along a length direction; the swing arm shaft 215 is provided with a positioning part 2151 and a lug boss 2152; the lug boss 2152 is arranged in the second hole section 21633; the positioning part 2151 is arranged in the first hole section 21631; an elastic element 217 is arranged in the second hole section 21633; and both ends of the elastic element 217 are abutted against one side of the annular convex block 21632 close to the second hole section 21633 and the lug boss 2152 respectively to abut the positioning part 2151 against one side of the annular convex block 21632 away from the second hole section 21633.

The user can exert a force on the massage ball head 216 to press the massage ball head 216 towards the swing arm shaft 215 and compress the elastic element 217, so that the positioning part 2151 is separated from the annular convex block 21632. At this time, the user can control the massage ball head 216 and the swing arm shaft 215 to rotate relatively. Through this operation, the first use state or the second use state of the massage device is selected. After the user releases the massage ball head 216, the elastic element 217 is restored so that both ends of the elastic element 217 are abutted against the annular convex block 21632 and the lug boss 2152 respectively. Thus, the positioning part 2151 is abutted against the annular lug boss 2152, and the massage ball head 216 is fixed relatively to the swing arm shaft 215.

By referring to FIG. 11, to improve the fixing effect between the massage ball head 216 and the swing shaft and to avoid rotation of the massage ball head 216 relative to the swing shaft when the massage device is used, in one or more embodiments, one side of the annular convex block 21632 away from the second hole section 21633 is provided with a positioning groove 21634, and the positioning part 2151 is arranged in the positioning groove 21634.

The above only describes embodiments of the present application, and is not intended to limit the patent scope of the present application. Any equivalent transformation made by using contents of the description and drawings of the present application, or directly or indirectly used in relevant technical fields shall be similarly included within the protection scope of patent of the present application.

1. A massage device, comprising a shell, wherein a driving assembly and two groups of massage assemblies are arranged in the shell; the massage assemblies are arranged on both sides of the driving assembly; each group of massage assemblies comprises a massage swing arm and a kneading gripper; the driving assembly comprises a motor and a spindle; the motor is in transmission connection with the spindle; the two groups of massage assemblies are arranged on both ends of the spindle respectively; the massage swing arm is arranged on the spindle through a bevel seat; the massage swing arm is provided with a fixing shaft; swing grooves are arranged in the shell; the fixing shaft is arranged in the swing grooves; the kneading gripper is arranged on the spindle through a bevel cam; the kneading gripper is provided with a deflection chute; a limiting shaft is arranged in the shell; and the limiting shaft is arranged in the deflection chute.

2. The massage device according to claim 1, wherein the driving assembly further comprises a main rotating shaft gear; the main rotating shaft gear is sleeved on the spindle; and the main rotating shaft gear is in transmission connection with the motor.

3. The massage device according to claim 2, wherein the driving assembly also comprises a driving housing, and the limiting shaft is arranged on the driving housing; the driving housing comprises an upper driving housing and a lower driving housing; the spindle is penetrated on the lower driving housing; the motor is arranged outside the lower driving housing; the lower driving housing is provided with a through hole; the motor is provided with an output worm, the output worm extends into the lower driving housing through the through hole; and the output worm is in transmission connection with the main rotating shaft gear.

4. The massage device according to claim 3, wherein the driving assembly also comprises duplex gears; the duplex gears are arranged in the lower driving housing; the duplex gears comprise an inner gear and an outer gear; the output worm and the outer gear are engaged; and the inner gear and the main rotating shaft gear are engaged.

5. The massage device according to claim 3, wherein the spindle is provided with two bearing sleeves, the lower driving housing is provided with two bearing grooves, and the bearing sleeves are embedded into the bearing grooves.

6. The massage device according to claim 3, wherein the limiting shaft is arranged on two outer sides of the driving housing.

7. The massage device according to claim 1, wherein one side of the bevel cam is provided with a first fixing piece; the first fixing piece is used for limiting the kneading gripper on the bevel cam; one side of the bevel seat is provided with a second fixing piece; and the second fixing piece is used for limiting the massage swing arm on the bevel seat.

8. The massage device according to claim 1, wherein an inner ring of the bevel cam is provided with a locking shaft, the spindle is provided with a locking hole, and the locking shaft is inserted into the locking hole.

9. The massage device according to claim 1, wherein the bevel cam is provided with a connecting shaft; the connecting shaft is arranged in a circumferential direction relative to the bevel seat; the bevel seat is provided with a connecting hole; and the connecting shaft is inserted into the connecting hole.

10. The massage device according to claim 1, wherein the shell comprises an upper housing and a lower housing; the driving assembly is arranged in the lower housing; the swing grooves are arranged on both sides in the lower housing; the upper housing is provided with avoidance holes; and the massage swing arm and the kneading gripper penetrate through the avoidance holes and extend out of the upper housing.

11. The massage device according to claim 1, wherein the massage assembly is arranged in a mirror image on the driving assembly, the massage swing arm is arranged on the spindle near a position of an end, and the kneading gripper is arranged on the spindle near a position of the motor.

12. The massage device according to claim 1, wherein the massage swing arm comprises a swing arm shaft and a massage ball head; one end of the swing arm shaft is provided with the massage ball head; and the other end of the swing arm shaft is arranged on the spindle through the bevel seat.

13. The massage device according to claim 12, wherein the massage ball head comprises a first ball head part and a second ball head part, and the width of the first ball head part is greater than the width of the second ball head part.

14. The massage device according to claim 12, wherein the massage ball head comprises a first ball head part and a second ball head part, and the length of the first ball head part is greater than the length of the second ball head part.

15. The massage device according to claim 12, wherein the massage ball head is rotatably connected with the swing arm shaft.

16. The massage device according to claim 12, wherein the massage ball head is provided with an installing hole; the swing arm shaft is movably arranged in the installing hole; the installing hole comprises a first hole section, an annular convex block and a second hole section arranged successively along a length direction; the swing arm shaft is provided with a positioning part and a lug boss; the lug boss is arranged in the second hole section; the positioning part is arranged in the first hole section; an elastic element is arranged in the second hole section; and both ends of the elastic element are abutted against one side of the annular convex block close to the second hole section and the lug boss respectively to abut the positioning part against one side of the annular convex block away from the second hole section.

17. The massage device according to claim 16, wherein one side of the annular convex block away from the second hole section is provided with a positioning groove, and the positioning part is arranged in the positioning groove.

18. A massage device, comprising a shell, wherein a driving assembly and two groups of massage assemblies are arranged in the shell; the massage assemblies are arranged on both sides of the driving assembly; each group of the massage assemblies comprises a massage swing arm and a kneading gripper; the driving assembly is used for swinging the massage swing arms and the kneading grippers; the driving assembly comprises a driving housing, a motor, a main rotating shaft gear and a spindle; the motor is used for driving the main rotating shaft gear to rotate; the main rotating shaft gear is sleeved on the spindle; the spindle rotates with the main rotating shaft gear; the two groups of massage assemblies are arranged at both ends of the spindle respectively; the massage swing arm is arranged on the spindle through the bevel seat; the bevel seat rotates with the spindle; the bottom of the massage swing arm is provided with a fixing shaft; a swing groove is arranged below the massage swing arm; the fixing shaft is arranged in the swing groove; the kneading gripper is arranged on the spindle through the bevel cam; the bevel cam rotates with the spindle; the kneading gripper is provided with a deflection chute for limiting; the driving housing is provided with a limiting shaft; and the limiting shaft is arranged in the deflection chute.
